(19) United States
(12) Patent Application Publication
(10) Pub. No.: US 2022/0032773 A1
(43) Pub. Date: Feb. 3, 2022

(54) PANEL DEVICE

(71) Applicant: KABUSHIKI KAISHA TOKAI RIKA DENKI SEISAKUSHO, Aichi (JP)

(72) Inventors: Akito Ishihara, Aichi (JP); Yusuke Nomura, Aichi (JP); Yuki Sakai, Aichi (JP)

(21) Appl. No.: 17/388,977

(22) Filed: Jul. 29, 2021

(30) Foreign Application Priority Data
Aug. 3, 2020 (JP) 2020-131705
May 27, 2021 (JP) 2021-089313

(51) Int. Cl. B60K 35/00; G02F 1/1335

(52) U.S. Cl. CPC B60K 35/00; G02F 1/133512; B60K 2370/691; B60K 2370/334; B60K 2370/349; B60K 2370/1434

(57) ABSTRACT

A panel device includes a concealing portion that allows light to pass and blurs the edge of an opening in a light-blocking layer. The light-blocking layer is arranged at the rear side of a panel unit and forms the black background of the panel unit. The concealing portion of the panel device blurs the contour of the opening in the light-blocking layer when light is emitted from the rear side of the panel device and a representation is displayed on the panel unit.

### BACKGROUND

### 1. Field

The following description relates to a panel device that displays representations.

### 2. Description of Related Art

Japanese Patent No. 6350489 discloses a conventional display device as an example of a panel device for a vehicle that is used for operating on-board devices of a vehicle. The display device includes, for example, an outer panel, a liquid crystal display, and a display formation plate. An image displayed by the liquid crystal display is projected through the display formation plate onto the outer panel so that the display device shows various representations on the outer panel.

### SUMMARY

The display formation plate includes, for example, a light-projecting base material sheet, a light-blocking printed layer, and a tinted printed layer. The light-blocking printed layer includes an opening through which light from the liquid crystal display is transmitted to project an image from the liquid crystal display onto the outer panel. With this structure, the contour of the opening can be seen when the outer panel is viewed from the outer side. This adversely affects the aesthetic appeal of the panel device.

One objective of the present disclosure is to provide a panel device that has a high aesthetic appeal.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a panel device includes a panel unit, a light-blocking layer, a light source, and a concealing portion. The panel unit is light-transmissive and one of colored or colorless. The light-blocking layer includes an opening shaped in correspondence with a representation displayed on the panel unit. The light source emits light from a rear side of the panel unit and displays the representation on the panel unit with the light passing through the opening. The concealing portion blurs an edge of the opening when the light emitted from the light source passes through the opening so that the opening is relatively unnoticeable from an outer side.

### Definitions

The opening includes at least one of a window frame, a mark opening, and an indicator opening. The representation includes at least one of an image, a mark, and an indicator.

The panel device of the present disclosure has a high aesthetic appeal.

Other features and aspects will be apparent from the following detailed description, the drawings, and the claims.

### BRIEF DESCRIPTION OF THE DRAWINGS

FIG. 1 is a front view of a panel device in accordance with an embodiment.

FIG. 2 is a cross-sectional view of the panel device.

FIG. 3 is a cross-sectional view showing the structure of a display.

FIG. 4 is a cross-sectional view showing the structure of a symbol portion.

FIG. 5 is a cross-sectional view showing the structure of an indicator portion.

FIG. 6 is a diagram showing the electric configuration of the panel device.

FIG. 7 is a rear view of a panel unit on which a light-blocking layer and a concealing portion is formed.

FIG. 8 is a front view of a panel device in accordance with another example.

FIG. 9 is a front view of a panel device in accordance with a further example.

FIG. 10 is a front view of a panel device in accordance with a further example.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

An embodiment of a panel device will now be described. In the description hereafter, to facilitate understanding, configurations may be partially exaggerated or simplified in the drawings. Further, elements in the drawings may not be to scale.

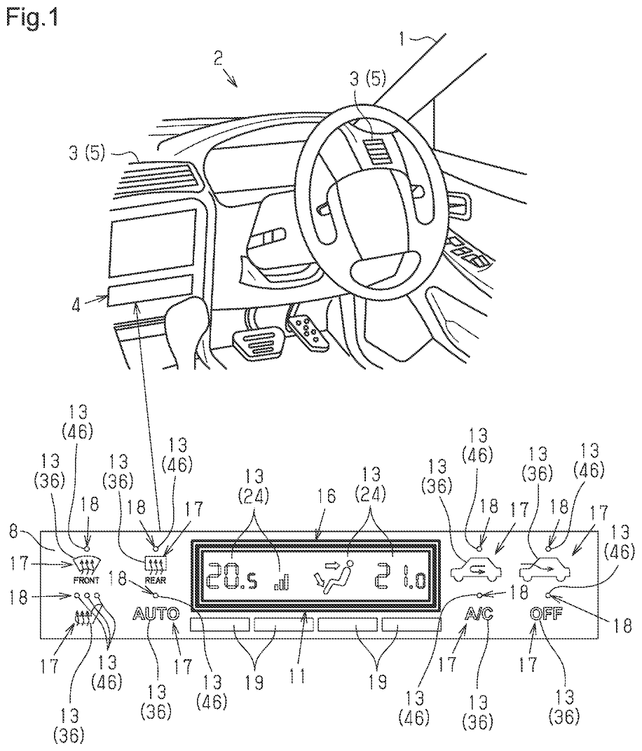

As shown in FIG. 1, a panel device 4 is arranged near a driver seat 2 of a vehicle 1 and operated to switch operation state of an on-board device 3. The panel device 4 is of a type that includes a panel display function, a touch-operation function, an indicator function, and the like. The panel display function displays, for example, the present operation state of the device 3 and shows symbols related to the device 3. The touch-operation function switches, for example, the operation state of the device 3 when the panel device 4 is touched. The indicator function indicates, for example, the operation state of the device 3 by switching a light on and off. The device 3 includes, for example, an air conditioner 5 that air-conditions the passenger compartment.

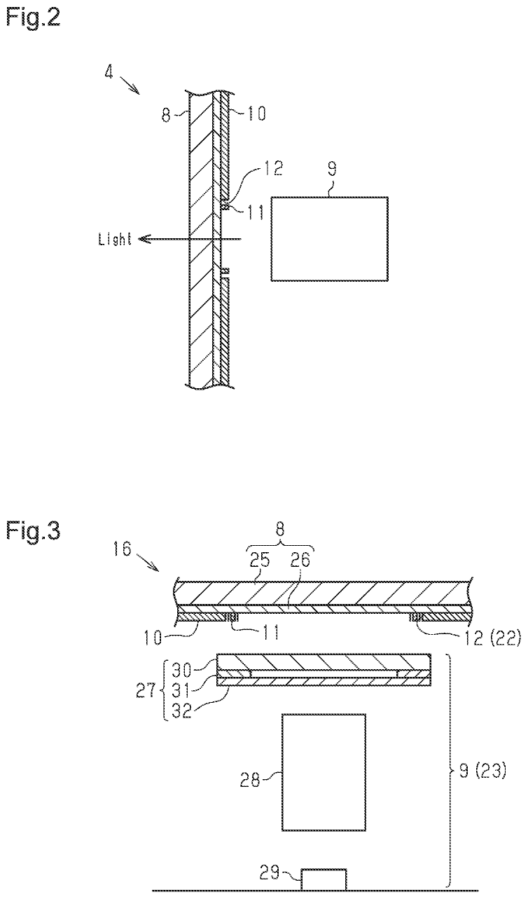

As shown in FIG. 2, the panel device 4 includes a panel unit 8, a light source 9, a light-blocking layer 10, and a concealing portion 11. In the description hereafter, a rear side refers to the side of the panel unit 8 opposite to the outer side that is visible to the user. The rear side of the panel unit 8 is where a light projector 45 is located. Further, a rear surface refers to a surface directed toward the side opposite to the visible side. The panel unit 8, which is light-transmissive, is colored or colorless. In the present example, the panel unit 8 is colored and light-transmissive. The panel unit 8 has, for example, a black background corresponding to the color of the light-blocking layer 10, which is printed in black (black printed). The light-blocking layer 10 includes an opening 12 that is shaped in correspondence with a representation 13 shown on the panel unit 8 (refer to FIG. 1, etc.). The light source 9 emits light from the rear side of the panel unit 8, and the representation 13 is displayed on the panel unit 8 by the light passing through the opening 12. The concealing portion 11 blurs the periphery of the opening 12 and conceals the opening 12 when the light emitted from the light source 9 passes through the opening 12 so that the opening 12 is relatively unnoticeable from the outer side.

As shown in FIG. 1, the panel device 4 includes a display 16, symbol portions 17, and indicator portions 18. The display 16 shows the present operation state of the device 3 on the panel device 4. The symbol portions 17 implement the touch-operation function of the panel device 4. The indicator portions 18 implement the indicator function of the panel device 4. The panel device 4 may only include at least one of the display 16, the symbol portions 17, and the indicator portions 18. In the present example, the panel device 4 includes all three.

The symbol portions 17 are paired with the corresponding indicator portions 18. A single symbol portion 17 may be combined with a single indicator portion 18 to form a single set. Alternatively, a single symbol portion 17 may be combined with multiple indicator portions 18 to form a set. In the present example, the symbol portion 17 for a seat heater is provided with multiple (three in present example) indicator portions 18.

The panel device 4 includes multiple switches 19 operated to switch states of various functions shown on the display 16. Each switch 19 is, for example, a toggle switch. The switches 19 are arranged in correspondence with the representations 13 shown on the display 16. In the present example, the switches 19 include a driver seat temperature adjustment switch 19, a fan mode switch 19, an airflow adjustment switch 19, and a passenger seat temperature adjustment switch 19.

As shown in FIG. 3, the display 16 includes a window frame 22 that defines an opening 12 and an image displaying unit 23 that serves as the light source 9. The concealing portion 11 extends along the window frame 22. In other words, the concealing portion 11 extends along the inner side of the window frame 22. The light-blocking layer 10 includes an inner edge 12(22) that defines the opening 12. The concealing portion 11 extends along an inner side of the inner edge 12(22). In an example, the concealing portion 11 extends along the inner side of the inner edge 12(22) in the same layer as the light-blocking layer 10. The window frame 22 is arranged opposing the light source 9. The image displaying unit 23 projects an image 24 that serves as the representation 13 from the rear side of the panel unit 8 through the window frame 22 onto the panel unit 8. This displays the image 24 on the panel unit 8.

The specific structure of the display 16 will now be described. The panel unit 8 includes, for example, a resin panel 25 and a rear film 26. The resin panel 25 is, for example, a tinted panel (light attenuation member). The rear film 26 is adhered to the rear surface of the resin panel 25. For example, the rear film 26 includes a transparent film. The panel unit 8 may be, for example, flat or curved.

The light-blocking layer 10 is arranged on, for example, the rear surface of the rear film 26. In an example, the light-blocking layer 10 is printed in black. The light-blocking layer 10 is printed on, for example, the rear surface of the rear film 26. The light-blocking layer 10 is formed from a material that does not transmit light from the image displaying unit 23 to the panel unit 8. The light-blocking layer 10 is formed by performing, for example, laser printing, screen printing, ink-jet printing, pad printing, or the like.

The image displaying unit 23 includes, for example, a displaying unit 27, a lens 28, and a light emitting element 29. The displaying unit 27 includes an image display module 30 configured to display various images. The image display module 30 may be, for example, a liquid crystal display (LCD) or an organic light emitting diode (OLED) display. A diffusion sheet 32 is attached to the rear surface of the image display module 30 by a locally arranged tape member 31. The tape member 31 is, for example, double-sided tape. The light emitting element 29 is, for example, a light emitting diode (LED). The lens 28 increases the brightness of the light emitting element 29.

The concealing portion 11 is arranged on the rear surface of the panel unit 8. The light-blocking layer 10 and the concealing portion 11 are formed in the same layer. The concealing portion 11 is formed by, for example, part of the light-blocking layer 10. The concealing portion 11 is used to conceal the contour of the window frame 22 so that it is relatively unnoticeable from the outer side. The concealing portion 11 is, for example, printed in a manner achieving at least one of gradual color changing, color gradation, color blurring, and color shading.

As shown in FIG. 1, the concealing portion 11 is, for example, a design of lines formed by combining three rectangles. In the present example, the concealing portion 11 is a design using three rectangles that differ in size and share the same center. Specifically, in the design of the concealing portion 11, the outermost rectangle and the innermost rectangle are formed by lines of the same width, and the rectangle located in between is formed by lines wider than those of the outermost and innermost rectangles.

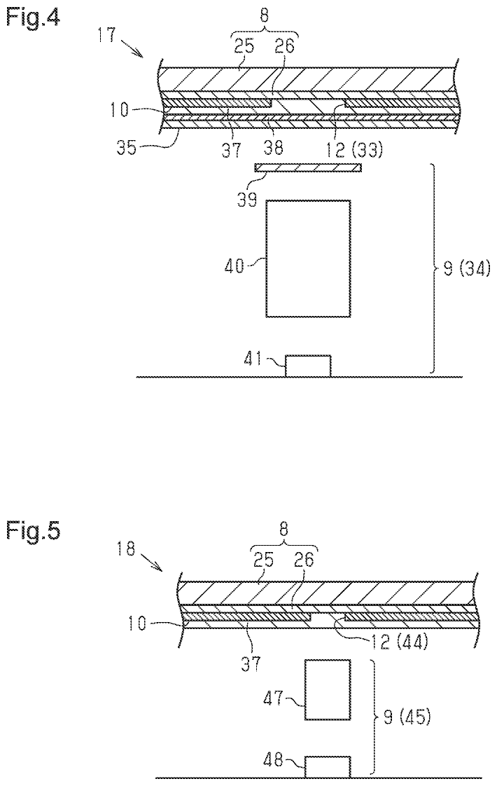

As shown in FIG. 4, each symbol portion 17 includes a mark opening 33 that serves as the opening 12, a light projector 34 that serves as the light source 9, and a detector 35. The mark opening 33 is shaped in correspondence with a mark 36 that serves as the representation 13. The light projector 34 emits light from the rear side of the panel unit 8 through the mark opening 33 to display the mark 36, which is shaped in correspondence with the mark opening 33, on the panel unit 8. The detector 35 is located inward from the mark opening 33 to detect when the panel unit 8 is touched at the mark opening 33.

The specific structure of the symbol portion 17 will now be described. Each mark opening 33 is formed in the light-blocking layer 10 and shaped in correspondence with the mark 36. For example, when the device 3 is the air conditioner 5, the mark 36 includes at least one of a front window defroster mark, a rear window defroster mark, a seat heater mark, an automatic operation mark, an air recirculation mark, an outside air mark, an air conditioner mark, and an OFF mark. A light attenuation layer 37, or a tinted layer, is formed on the rear surface of the light-blocking layer 10 to obtain the black appearance of the panel unit 8. The light attenuation layer 37 is formed on the entire rear surface of the light-blocking layer 10 and fills each mark opening 33.

The detector 35 is attached to the rear surface of the light attenuation layer 37 by a tape member 38. The detector 35 is, for example, a capacitance sensor. Alternatively, the detector 35 may use, for example, a resistive film, surface capacitance, projected capacitance, an ultrasonic surface acoustic wave, an optic sensor, or electromagnetic induction. The detector 35 detects when the panel unit 8 is touched at the mark 36. For example, the detector 35 has the shape of a sheet. The detector 35 is transparent (transparent electrode) so that the light from the light source 9 reaches the panel unit 8.

The light projector 34 includes, for example, a diffusion sheet 39, a lens 40, and a light emitting element 41. The diffusion sheet 39 is located between the detector 35 and the lens 40. The diffusion sheet 39 is, for example, a white sheet that transmits light. The light emitting element 41 is, for example, a light emitting diode (LED). The lens 40 increases the brightness of the light emitting element 41.

As shown in FIG. 5, each indicator portion 18 includes an indicator opening 44 that serves as the opening 12 and the light projector 45 that serves as the light source 9. The indicator opening 44 is shaped in correspondence with an indicator 46 that serves as the representation 13. The light projector 45 emits light from the rear side of the panel unit 8 through the indicator opening 44 to display the indicator 46, which is shaped in correspondence with the indicator opening 44, on the panel unit 8.

The specific structure of the indicator portion 18 will now be described. The indicator opening 44 is formed in the light-blocking layer 10 and shaped in correspondence with the indicator 46. The indicator opening 44 is, for example, circular. A single indicator portion 18 or multiple (three in present example) indicator portions 18 are provided for a single symbol portion 17. When multiple indicator portions 18 are provided for a single symbol portion 17, the indicator portions 18 are, for example, located adjacent to one another. The light attenuation layer 37 is arranged on the rear surface of the light-blocking layer 10 and fills each indicator opening 44. The symbol portion 17 and the indicator portion 18 do not have to share the same light attenuation layer 37 and may use separate light attenuation layers 37.

The light projector 45 includes, for example, a lens 47 and a light emitting element 48. The light emitting element 48 is, for example, a light emitting diode (LED). The lens 47 increases the brightness of the light emitting element 48.

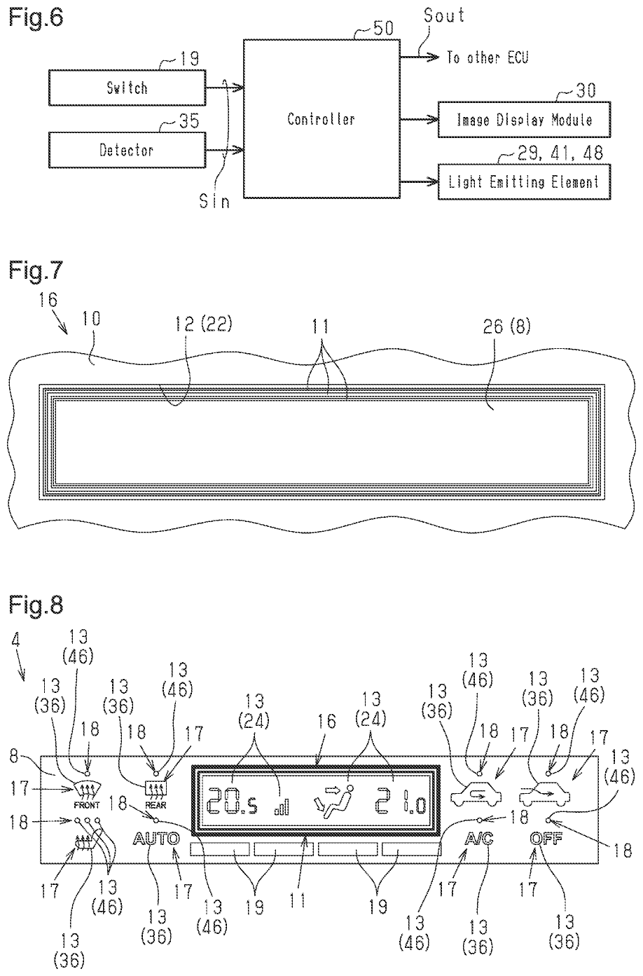

As shown in FIG. 6, the panel device 4 includes a controller 50 that controls the panel device 4. The controller 50 receives inputs from the switches 19 and the detector 35. The controller 50 sends an output to another ECU, the image display module 30, and the light emitting elements 29, 41, and 48. The controller 50 detects a user operation performed in the panel unit 8 based on input signals Sin from the switches 19 and the detector 35. Then, the controller 50 outputs an operation signal Sout corresponding to the detection result to the other ECU. The other ECU is, for example, the ECU of the device 3. The controller 50 controls the image display module 30 and the light emitting elements 29, 41, and 48 based on the input signals Sin to switch the state of each representation 13.

The operation of the panel device 4 in the present embodiment will now be described.

As shown in FIG. 7, the panel unit 8 is prepared in a manufacturing process of the panel device 4, and the concealing portion 11 is formed on the rear surface of the panel unit 8 in a looped manner along the opening of the window frame 22. The concealing portion 11 is formed by performing, for example, laser printing, screen printing, ink-jet printing, pad printing, or the like. The concealing portion 11 may be formed at the same time as when the light-blocking layer 10 is formed or after the light-blocking layer 10 is formed.

If the panel device 4 does not include the concealing portion 11, a difference in color between the window frame 22 and the displaying unit 27 would cause the opening of the window frame 22 to be visible from the outer side. Accordingly, when the panel unit 8 is viewed from the outer side, the opening of the window frame 22 will form noticeable lines. This adversely affects the aesthetic appeal of the panel device 4.

In the present example, as shown in FIG. 1, the concealing portion 11 is arranged along the edge of the window frame 22 in the display 16 to blur the contour of the window frame 22. In this manner, the opening of the window frame 22 is hidden, and the panel unit 8 is thus uniform in color. In particular, when the panel device 4 is black, the panel unit 8 also appears as black. This improves the aesthetic appeal of the panel device 4.

The panel device 4 in the above embodiment has the following advantages.

(1) In the panel device 4, which includes the panel unit 8, the light source 9, and the light-blocking layer 10, the concealing portion 11 is arranged to allow light to pass while blurring the edge of the opening in the light-blocking layer 10. With this structure, when the light source 9 emits light and the representation 13 is displayed on the panel unit 8, the concealing portion 11 arranged on the panel device 4 blurs the contour of the opening 12 in the light-blocking layer 10. In this manner, even when the structure is such that the light of the light source 9 reaches the panel unit 8 through the opening 12 of the light-blocking layer 10 to display the representation 13 on the panel unit 8, the contour of the opening 12 is relatively unnoticeable from the outer side of the panel unit 8. This improves the aesthetic appeal of the panel device 4.

(2) The concealing portion 11 is arranged on the rear surface of the panel unit 8. With this structure, the concealing portion 11 is not exposed to the outer side. This avoids damage and wear of the concealing portion 11.

(3) The light-blocking layer 10 and the concealing portion 11 are formed on the same layer. With this structure, the light-blocking layer 10 and the concealing portion 11 can be formed simultaneously during, for example, a printing process. This simplifies the manufacturing process.

(4) The concealing portion 11 is a printed in a manner achieving at least one of gradual color changing, color gradation, color blurring, and color shading. With this structure, the opening 12 is hidden by the design that sufficiently conceals the contour of the opening 12.

(5) The panel unit 8 has a black background corresponding to the color of the light-blocking layer 10. With this structure, the panel unit 8 has a uniform black color. The black base color improves the aesthetic appeal of the panel device 4.

(6) The display 16 of panel device 4 includes the window frame 22 and the image displaying unit 23. With this structure, the concealing portion 11 blurs the edge of the window frame 22 in the display 16. In this manner, the window frame 22 of the display 16 is relatively unnoticeable in the panel unit 8. This improves the aesthetic appeal of the panel unit 8.

(7) Each symbol portion 17 in the panel device 4 includes the mark opening 33, the light projector 34, and the detector 35. With this structure, the operable marks 36 that are displayed on the panel unit 8 improve the aesthetic appeal of the panel device 4.

(8) Each indicator portion 18 in the panel device 4 includes the indicator opening 44 and the light projector 45. With this structure, the indicators 46 displayed on the panel unit 8 improve the aesthetic appeal of the panel device 4.

The present embodiment may be modified as follows. The present embodiment and the following modifications can be combined as long as the combined modifications remain technically consistent with each other.

As shown in FIG. 8, when the concealing portion 11 is formed by combining the lines of three rectangles, for example, the outermost rectangle may have the widest lines, the middle rectangle may have the second widest lines, and the innermost rectangle may have the narrowest lines. In this manner, the concealing portion 11 may be obtained by a group of rectangles having respective line thicknesses that become gradually narrower inward. In this case, the contour of the opening 12 is also relatively unnoticeable.

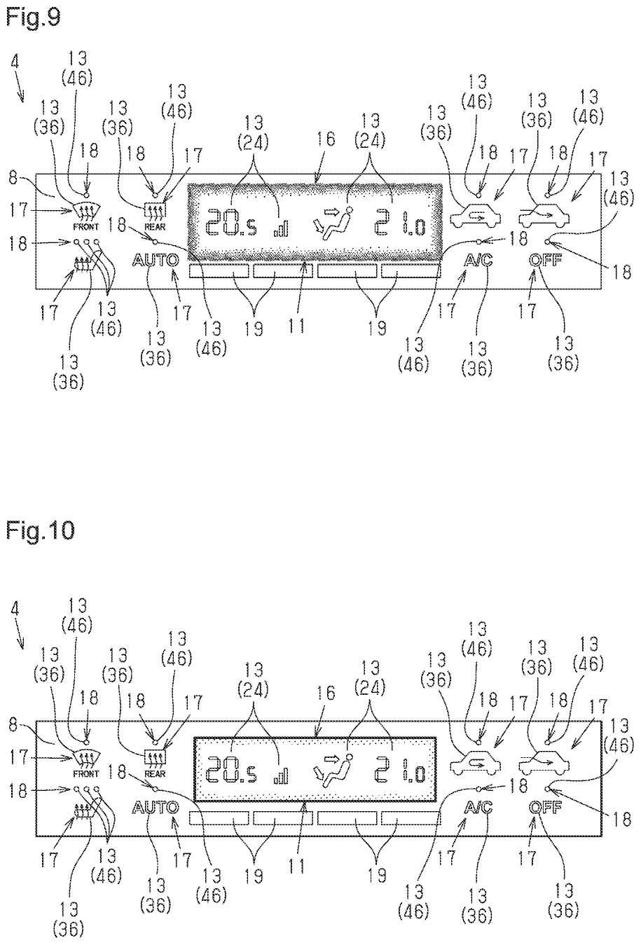

As shown in FIG. 9, the concealing portion 11 may blur the contour of the opening 12 with, for example, dots that vary in size, number, or ratio depending on location. In this case, the contour of the opening 12 is relatively unnoticeable.

As shown in FIG. 10, the concealing portion 11 may be obtained by, for example, a combination of lines and dots. In this case, the contour of the opening 12 is relatively unnoticeable.

The concealing portion 11 does not have to be formed on the rear surface of the panel unit 8 and may be arranged on, for example, a surface of the lens 28.

The concealing portion 11 may be a separate member located between the light source 9 and the light-blocking layer 10.

The concealing portion 11 may be a printed in a color other than black.

The structure of the light source 9 may be changed. For example, the lens and the diffusion sheet may be omitted.

The light-blocking layer 10 may be a sheet formed continuously on the display 16, the symbol portion 17, and the indicator portion 18. Alternatively, the light-blocking layer 10 may be sheets separated from one another between the display 16, the symbol portion 17, and the indicator portion 18.

The light source of the display 16 may be a member other than an LED. The same applies to the symbol portion 17 and the indicator portion 18.

The switch 19 is not limited to a toggle switch and may be changed to a push-button, a dial switch, or the like.

The panel device 4 may only include at least one of the display 16, the symbol portion 17, and the indicator portion 18.

The panel device 4 is not limited for use with a vehicle on-board device and may be used for other devices or apparatus. In other words, the panel device 4 may be installed in any object as long as the object notifies a user of various types of information related to the operation of the device 3 with the representation 13.

The present disclosure described in accordance with examples is to be considered as illustrative and not restrictive, and the present disclosure is not to be limited to the details given herein, but may be modified within the scope and equivalence of the appended claims.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A panel device, comprising:
a panel unit that is light-transmissive and one of colored or colorless;
a light-blocking layer including an opening shaped in correspondence with a representation displayed on the panel unit;
a light source that emits light from a rear side of the panel unit and displays the representation on the panel unit with the light passing through the opening; and
a concealing portion that blurs an edge of the opening when the light emitted from the light source passes through the opening so that the opening is relatively unnoticeable from an outer side.

2. The panel device according to claim 1, wherein the concealing portion is arranged on a rear surface of the panel unit.

3. The panel device according to claim 1, wherein the light-blocking layer is formed on a layer on which the concealing portion is formed.

4. The panel device according to claim 1, wherein the concealing portion is printed in a manner achieving at least one of gradual color changing, color gradation, color blurring, and color shading.

5. The panel device according to claim 1, wherein the panel unit includes a black background corresponding to a color of the light-blocking layer.

6. The panel device according to claim 1, comprising:
a display that includes
a window frame; and
an image displaying unit that serves as the light source and projects an image as the representation from the rear side of the panel unit through the window frame onto the panel unit to display the image on the panel unit,
wherein the concealing portion is formed along the window frame that defines the opening in the display.

7. The panel device according to claim 1, comprising:
a symbol portion that includes
a mark opening shaped in correspondence with a mark serving as the representation,
a light projector that serves as the light source and emits light from the rear side of the panel unit to the mark opening to display the mark, which is shaped in correspondence with the mark opening, on the panel unit, and
a detector arranged inward from the mark opening to detect when the panel unit is touched at the mark.

8. The panel device according to claim 1, comprising:
an indicator portion that includes
an indicator opening shaped in correspondence with an indicator serving as the representation, and
a light projector that serves as the light source and emits light from the rear side of the panel unit to the indicator opening to display the indicator, which is shaped in correspondence with the indicator opening, on the panel unit.
